(19) United States
(12) Patent Application Publication
(10) Pub. No.: US 2014/0330663 A1
(43) Pub. Date: Nov. 6, 2014

(54) REVERSE AUCTIONS FOR CONSUMER PRODUCTS AND SERVICES

(71) Applicant: Daniel M. CHAMBERS, Solana Beach, CA (US)

(72) Inventor: Daniel M. CHAMBERS, Solana Beach, CA (US)

(21) Appl. No.: 14/217,458

(22) Filed: Mar. 17, 2014

Related U.S. Application Data
(60) Provisional application No. 61/802,632, filed on Mar. 16, 2013.

(51) Int. Cl. G06Q 30/08; G06Q 30/02

(52) U.S. Cl. CPC G06Q 30/08; G06Q 30/0283
USPC 705/26.3

(57) ABSTRACT

The present invention concerns computer-based methods and systems for performing buyer-initiated reverse auctions to purchase consumer products and services. The invention allows a prospective buyer who commits to purchase a particular consumer good or service for not more than a buyer-specified price to initiate a reverse auction online amongst accredited vendors of the consumer product or service in order to purchase the product or service on terms at least as favorable as initially specified by the buyer. In a preferred embodiment, a computer system according to the invention includes a network computer that receives particular product/service descriptions and buyer-specified price ceilings from financially committed buyers. The system then initiates a reverse auction amongst accredited potential vendors who bid against one another in an effort to secure the sale. Upon the auction's closing, the accredited vendor that offered the most favorable terms to the buyer is awarded the sale. The vendor is then paid and the product or service delivered or provided to the buyer. The present invention will revolutionize commerce by empowering buyers to purchase products and services at or below prices they determine.

### RELATED APPLICATION

This application claims the benefit of and priority to U.S. provisional patent application Ser. No. 61/802,632 (attorney docket no. DMC-1010-PV), the contents of which are hereby incorporated by reference for any and all purposes.

### FIELD OF THE INVENTION

This invention concerns buyer-initiated reverse auctions conducted over computer networks.

### BACKGROUND OF THE INVENTION

1. Introduction.

The following description includes information that may be useful in understanding the present invention. It is not an admission that any such information is prior art, or relevant, to the presently claimed invention, or that any publication specifically or implicitly referenced is prior art.

2. Background.

Today in the U.S., consumer spending accounts for more than 70% of the country's almost $16 trillion economy. In this free market-based system, almost all buyer-vendor interactions are vendor-oriented in that they are based on methods and processes that allow vendors to price, package, and configure goods and services to their advantage. In-store displays, online, print, radio, and television advertisements, telemarketing, auctions (including online auction services such as eBay), are all vendor-initiated and used to attract buyers.

As consumers are well aware, most goods and services sold at retail rely on a business model wherein a vendor sets a price and a buyer decides whether or not to accept that vendor-determined, non-negotiable fixed price. Of course, transactions for some goods and services involve negotiations between buyers and vendors over various terms of sale, particularly the purchase price to be paid.

Auctions are another business model available to vendors of goods and services, although in conventional forward auction systems, final sales prices are not fixed by a vendor. Instead, final sales prices are determined by attracting numerous potential buyers for the particular good or service who, as a group, determine the final selling price through a competition in which interested buyers make escalating bids as to the final sales price to be paid. Unless the auction is one wherein the vendor has established a “reserve” price (i.e., the lowest bid price that the vendor will accept and which, if not reached, allows the vendor to subsequently reject any or all bids submitted during the auction, the result of which is that the product remains unsold), the product or service is sold to the highest bidder during the auction period. Vendors using traditional auction houses, as well as online auction house such as eBay, employ this centuries' old business model.

Business models in which a single buyer solicits multiple potential vendors are also known. Such buyer-driven models include “wanted” advertisements, whereby a buyer advertizes for a good or service s/he/it wishes to purchase from anyone capable of supplying that good or service.

Another example of a buyer-driven model is Priceline's NAME YOUR OWN PRICE ® online service, whereby a consumer interested in purchasing airline tickets or hotel accommodations or renting a car enters a price s/he is willing to pay (in addition to other information, such as date ranges for travel, etc.) along with a commitment to pay if her/his price is accepted. After confirming that the prospective buyer has the funds available, the buyer's offer is then circulated to participating airlines, hoteliers, and/or rental car companies, as the case may be, to solicit acceptances and/or counteroffers. To date, however, such buyer-directed non-auction business models do not allow a buyer to optimize the terms of, particularly the price for, a particular purchase of a new good or service the buyer wishes to purchase; instead, such models merely seek to allow a buyer to identify a prospective vendor willing and able to provide the desired good or service at the buyer's specified price. Once such a vendor is identified, the buyer purchases the good or service from that vendor at the agreed price.

Still other examples of buyer-driven models are

3. Definitions.

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

An “accredited vendor” refers to a party having an existing retail or wholesale business that stocks, sells or provides, advertizes or offers to sell or provide, delivers, and/or can have delivered or provided without backorder the target product or service.

An “auction period” refers to a buyer- or system-defined time period during which a reverse auction (preferably conducted online) takes place. Such periods include optionally include those are from about 1-360 minutes, about 1-72 hours, about 1-60 days, or about 1-6 months.

A “descriptor” or “descriptor set” for a product or service refers to data or information that allows the target product or service to be distinguished from all other non-target products or services. A representative example of such a target product or service descriptor is the Universal Product Code (UPC), which uses a well-known barcode symbology widely utilized in Canada and the U.S. for inventory tracking of goods in stores, warehouses, etc. Other examples include EAN (International Article Number) barcodes used worldwide for marking products often sold at retail points of sale. UPC, EAN, and other Global Trade Item Numbers (GTINs) are trade item identifiers that uniquely and universally allow a particular trade item type to be identified in a database and distinguished from all other trade items in the same or another database. Other exemplary trade item descriptors are descriptor sets made up of several different types of data or information, such as catalog or part numbers, product names, and the like, often combined with other information such as manufacturer name.

A “system-derived descriptor analog” refers to a descriptor that is generated, preferably automatically by a computer, from buyer-specified data. For example, if a buyer inputs as a trade item descriptor a the name of product and its manufacturer, a computer can search for and identify the corresponding UPC code, which may then be used instead of or in addition to the descriptive information for trade item in the buyer-specified data.

A “financially committed buyer” refers to a buyer that has made funds irrevocably available to purchase a particular target product or service in the event of a closing for a reverse auction conducted in accordance with the invention for such product or service.

A “patentable” process, machine, or article of manufacture according to the invention means that the invention as claimed satisfies all statutory requirements for patentability at the time the particular analysis is performed. For example, with regard to novelty, non-obviousness, or the like, if post-issuance investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards for assessing whether a particular statutory requirement for patentability is satisfied change from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

A “purchase order” is an electronic or written record or writing that constitutes a contractual offer the acceptance of which, along with the specified consideration, results in the formation of a legally binding contract.

A “reverse auction” refers to an auction system wherein price-optimized acceptance of a financially committed buyer's purchase offer for a target product or service is solicited from a plurality of accredited vendors of the target product or service. Price-optimized acceptance is achieved by allowing the solicited accredited vendors to participate in an online auction in which bids are sorted by purchase price, and the winning bid is selected as the lowest purchase price submitted, or, if two or more bids of the same purchase price are submitted, the bid that is most favorable to the buyer with regard to at least one other o criterion (e.g., delivery date, vendor location, vendor size, vendor identity, etc.).

A “target product or service” refers to a new good or a service that a buyer wishes to acquire, typically by purchase, although leasing, rental, and other transactions involving defined payment terms are also envisioned.

A “trade item” refers to any product or service that may be priced, ordered, invoiced, or retrieved at any point in any supply chain.

### SUMMARY

The present invention allows consumers to optimize the terms, particularly the purchase price, of transactions for new consumer products and services. In so doing, since the purchase price for a good or service is often the primary determinant as to not only whether a consumer will purchase a particular good or service at all but also as to how s/he may subsequently feel about the purchase (e.g., does s/he feel “good” about the purchase, does the buyer regret the purchase, did the buyer receive good “value” from the purchase, etc.), the invention will increase the likelihood of a consumer purchasing a target product or service, minimize the financial cost to the consumer of purchasing target products or services, and empower the consumer by enhancing the consumer's emotional response to the purchase.

Thus, one aspect the invention concerns reverse auction methods that allow for purchase price optimization from a buyer's perspective. Such methods utilize computers, and are preferably Internet or web-based online systems. The methods involve providing to a computer buyer-specified data that includes (i) at least one descriptor for a target product or service that allows the target product or service to be distinguished from all other non-target products or services and (ii) a ceiling purchase price for the target product or service. The buyer-specified data is used to generate a purchase order for target trade item the buyer wishes to purchase.

The instant methods also involve providing a payment indicator that evidences irrevocable availability of funds associated with the buyer in an amount sufficient to pay the buyer's ceiling purchase price if a closing occurs for a reverse auction corresponding to the purchase order. Additionally, the methods include an auction identifier so that the particular reverse auction corresponding to the purchase offer and payment indicator can be identified.

After obtaining the auction identifier, using the computer system initiates a reverse auction that corresponds to the purchase offer and payment indicator. The reverse auction has a defined auction period, which can be specified by the buyer, set by the system, or otherwise be specified in any suitable manner. The auction period optionally may be extended for one or more defined periods in the event of continued bidding activity just prior to closing of the auction.

The system initiates the reverse auction by making a binding buyer's purchase offer available to at least one accredited vendor, preferably by posting the buyer's purchase offer online. The buyer's purchase offer includes at least one of the trade item descriptors from the buyer-specified data (and/or system-derived descriptor analog therefore) and a trade item purchase price equal to or less than the buyer's ceiling purchase price. If desired, the system may also contact one or more accredited vendors of the trade item this is the subject of the reverse auction in order to apprise such vendor(s) of the reverse auction. Such contact can be made by any suitable modality, including email, text message, telephone, and/or fax, and can include information such as the auction identifier, the start and/or scheduled end time for the auction, the target trade item that is the subject of the auction, the buyer's ceiling purchase price, and/or such other information as the buyer and/or party controlling the computer system wishes to include.

During the auction period any accredited vendor aware of the reverse auction has the option to place one or more qualified bids intended to result in acceptance of the buyer's purchase offer. To proffer acceptance of the buyer's purchase offer, an accredited vendor must indicate at least a selling price equal to or less than the trade item purchase price. A vendor's proffered acceptance may also provide further agreements, commitments, information, and/or undertakings on the part of the vendor, for example, a commitment to deliver the target trade item upon receipt of payment of the final sales price, or, in some instances, a final transaction price, which is the sum of the final sales price and such other additional costs or expenses the buyer has agreed to bear, whether pursuant to the terms of the buyer's purchase offer or otherwise. Such other additional costs or expenses may include applicable sales and/or use taxes, shipping and delivery charges, insurance, extended warranties and/or service plans, etc.

If no accredited vendor proffers acceptance during the auction period, the auction may be closed or extended for one or more additional defined periods if approved by the buyer, in which event the accredited vendor(s) from whom acceptance was earlier solicited may be informed of such extension(s). If one accredited vendor proffers acceptance during the auction period, closing the auction at the conclusion of the auction period, fixing as the final sales price the selling price for the target product or service, and awarding the sale of the target product or service to such accredited vendor. If more than one accredited vendor proffers acceptance during the auction period, closing the auction at the conclusion of the auction period, awarding the sale of the target product or service to the accredited vendor that first proffered acceptance during the auction on terms most favorable to the buyer, and fixing as the final sales price the selling price proffered by the accredited vendor awarded the sale; alternatively, if two or more accredited vendors proffer acceptance just prior to the end of the auction period that, in the absence of the other proffered acceptance (s), would have won the auction for such accredited vendor, extending the auction period for one or more additional defined periods if approved by the buyer, in which event the accredited vendor(s) from whom acceptance was earlier solicited, or a subset of such vendors, may be informed of such extension(s).

As an alternative to closing the auction if no accredited vendor proffers acceptance during the auction period, if agreed by the buyer before or during the auction period the buyer's purchase offer then in effect may be revised to include a revised product/service purchase price greater than the product/service purchase price being replaced but equal to or less than the ceiling purchase price. Yet other alternative embodiments involve allowing such an auction to close without an acceptance and initiating a new auction according to the invention using either the same, or preferably a revised, product/service purchase price greater than the product/service purchase price from the immediately preceding auction but equal to or less than the ceiling purchase price specified in the buyer's purchase order.

If there is an acceptance during the auction period (or an extension thereof), the methods of the invention can also include so informing the buyer, preferably also then informing the buyer of the final sales price for the target trade item, facilitating the winning vendor's collection of payment of the final sales price, and/or facilitating delivery or provision of the target trade item to the buyer.

In other embodiments, the methods of the invention include in the buyer's purchase offer a “SELL IT NOW” price that is less than the product/service purchase price. In such embodiments, if at any point during the auction prior or term, or, alternatively, during a pre-bidding preview period preceding the bidding period of the auction period, an accredited vendor proffers acceptance by agreeing to sell the target product or service to the buyer at the “SELL IT NOW” price, the auction is then closed, the “SELL IT NOW” price is fixed as a final sales price, and the sale is awarded to the accredited vendor that agreed to complete the sale at the “SELL IT NOW” price.

Other embodiments of this aspect relate to extending the auction when more than one accredited vendor proffers acceptance during the auction period. In some of these embodiments, prior to closing the auction at the conclusion of the auction period, at least the accredited vendor who proffered an acceptance that included the second (or higher) lowest selling price the auction period is (are) apprised that at least one other vendor proffered the same or lower selling price and is (are) offered the opportunity to downwardly revise its (their) respective selling prices), if desired. In others, prior to closing the auction at the conclusion of the auction period, every accredited vendor other than the accredited vendor that proffered the lowest selling price is (i) apprised that another accredited vendor participating in the same reverse auction has proffered acceptance at a selling price less than such apprised vendor's respective selling price and (ii) allowed to downwardly revise its respective proffered selling price, if desired. In such embodiments, if an accredited vendor downwardly revises its selling price such that at the conclusion of the auction period it first proffered acceptance on terms most favorable to the buyer, the auction is closed, the final sales price is fixed at the downwardly revised selling price provided by such accredited vendor, and the sale is awarded to such accredited vendor.

Another aspect of the invention concerns computer systems configured to allow the reverse auction methods of the invention to be carried out thereon. Such systems include, in operable association, a power supply, one or more processors configured to execute computer control logic to perform a reverse auction in accordance with the instant invention, one or more computer interfaces that allow receipt of the data and information required to be provided by the buyer in order to complete the buyer's purchase order for the target product or service as well as the information or data required to be provided by each accredited vendor in order to complete such vendor's proffered acceptance, and one or more storage devices for storing data at least some of which is received through one more interfaces and at least some of the computer control logic used to perform the reverse auction.

Related aspects of the invention concern computer control logic for directing a computer to perform the reverse auction methods of the invention, as well as computer program products and memory devices embodying computer control logic.

Various features and advantages of the invention will appear from the following description in which the preferred embodiments have been set forth in detail in conjunction with the accompanying drawings.

### DETAILED DESCRIPTION

1. Introduction.

As those in the art will appreciate, the following detailed description describes certain preferred embodiments of the invention in detail, and is thus only representative and does not depict the actual scope of the invention. Before describing the present invention in detail, it is understood that the invention is not limited to the particular aspects and embodiments described, as these may vary. It is also to be understood that the terminology used herein is for the purpose of describing particular embodiments only, and is not intended to limit the scope of the invention defined by the appended claims.

2. The Invention.

The present invention concerns a business model that allows a buyer to optimize the terms of, particularly the price for, a particular purchase of a new good or service the buyer wishes to acquire. The invention employs a financially committed buyer-directed reverse auction, the primary objective of which is to drive purchase prices below a “ceiling price” set by the buyer upon consideration of pricing information available for the target trade item from one or more vendors. In contrast to a conventional “forward auction”, which allows a vendor to find the “best”, i.e., highest, price among two or more interested buyers, a reverse auction allows a buyer to find the lowest price vendor of the target trade item. Unlike traditional reverse auctions, however, where a buyer identifies a good or service s/he wishes to purchase and then solicits sales offers from multiple sellers, after which the buyer accepts the most favorable offer, the instant invention involves a financially committed buyer who desires to buy a target trade item extending a purchase offer to two or more accredited vendors to buy the target trade item (i.e., a target product service identified by a buyer) at a price determined by a dynamic , preferably online or Internet-based, bidding process, provided that the lowest auction-determined price is equal to or less than a ceiling price established by the buyer prior to the auction's initiation.

During a reverse auction according to the invention, each participating (i.e., bidding) accredited vendor submits at least one proffered acceptance. In many cases, the winning vendor may submit multiple proffered acceptances, typically in response to competing vendors' proffered acceptances. This process bids down the ultimate sales price of the target trade item, with each vendor ultimately proffering acceptance based on the lowest price it is willing to sell the good or service for. By revealing the competing bids, or at least the proffered acceptance with the then lowest price, in real time to each participating accredited vendor, preferably via a web-based graphical user interface, this open process promotes price transparency. Even so, the invention also includes “closed” embodiments where each participating vendor submits one proffered acceptance that is “sealed”, i.e., not revealed to the other participating vendors during the auction period.

As will be appreciated, the invention allows a consumer to purchase a particular desired good or service (or bundles of specific goods and/or services) for no more than, and frequently for less than, the ceiling price designated by the consumer. This serves to not only to increase the effective purchasing power of consumers (by allowing them to pay less than they otherwise would for a particular product, leaving them more money for other purchases and uses), but also to increase customer satisfaction, as the consumer will be less likely to believe or feel that s/he overpaid for a good or service when that trade item was purchased at or below the customer's ceiling price, or maximum price the customer felt comfortable in paying for the target good(s) and/or service(s). As explained in more detail below, there are different embodiments of the invention, including whether the bidding process is “open” or “closed”, what price is used to initiate the auction and how that price is selected, whether there is a “reserve” (i.e., “ceiling” price), the length of the auction period and whether it may be extended, whether the identities of participating vendors are revealed, whether there are limits on or minimum increments between bid prices in proffered acceptances, how the winning proffered acceptance is determined, etc.

Avoiding collusion among vendors and other problems: Whenever some or all of the vendors participating in a reverse auction know the identity of at least one other participating vendor, the risk of collusion (i.e., working together to prevent or reduce downward price pressure during the bidding process, often by agreeing to bid only against other vendors not known to any of the colluding vendors) among vendors arises. To minimize or eliminate this risk, in preferred embodiments, the actual identity of any accredited vendor is not disclosed during the bidding process. Vendor anonymity can be accomplished, for example, by randomly assigning each vendor a different number or other identification symbol.

In order to maintain the integrity of the auction process, in preferred embodiments the terms of the auction will provide that only accredited vendors can participate, and that no dummy bids are permitted which, if used, could deceive genuine participating accredited vendors into proffering acceptances with selling prices lower than they would have otherwise provided.

Determining the ceiling price:

Determining the product/service purchase price [note: this price could be higher than the ceiling price, in which event the ceiling price acts as a reserve price, meaning that unless bidding gets down to the ceiling price or lower, there will not be a closing]:

In order to achieve the most favorable outcome for the buyer, namely the lowest possible final sales price, a reverse auction will have many proffered acceptances placed by at least several accredited vendors. To achieve this, the opening bid, or starting purchase price, for a reverse auction according to the invention, namely the “product/service purchase price”, preferably is higher than the buyer's ceiling price for the target trade item. For example, the product/service purchase price could be established as the median, or average, price for the product observed using an online price comparison application such as PRICEGRABBER™ (PriceGrabber, Inc., Los Angeles, Calif.) or Google Products. Such a relatively high opening price, higher than the lowest advertized price that can be readily identified, for example, online, for the target trade item, will promote interest among vendors interested in participating in the auction. Experience with forward auctions reveals that final sales price as the numbers of bidders rise. Also, when there are many bids, most are low, and only a few are high, and without several low bids there will not be any high bids. By analogy, in a reverse auction it is preferred the auction period open with several bids quickly being made. By setting the opening sales price in an area where any winning vendor might achieve a high sales margin, multiple vendors will have an incentive to participate. As proffered selling prices fall during the bidding process, the number of participating vendors will likely decrease, and the bidding rate is also likely to decline, although it is not uncommon in the context of online forward auctions for the bidding rate to accelerate as the end of the auction period draws near.

Selecting products: For example, the REDLASER app:

Mobile device applications, such as are used on smartphones (e.g., Apple Inc.'s iPhone®), are available that allow a consumer to take a picture of or directly use a laser to scan a barcode on a label affixed to a product of interest. Such applications use the photo (or, alternatively, use a laser scanner to directly scan the barcode) and from it identify the product and then use Internet-based shopping or price comparison applications such as GOOGLE, The Find, etc. to obtain and present to the consumer via the mobile device's display screen price information for that product at various vendors located within a certain distance of mobile device. One example of such an application is RedLaser (eBay Inc.). RedLaser is a mobile device-based barcode-scanning application for comparison shopping and finding product information. RedLaser's barcode scanning technology is compatible with non-autofocus cameras found in many currently available smartphones and other mobile devices. A consumer can use an app such as RedLaser to select a target product and determine the ceiling price to be used in a reverse auction according to the invention, which are preferably conducted online, over the Internet.

All of the inventions described and claimed herein can be made and executed without undue experimentation in light of the specification. The terms and expressions which have been employed herein to described the invention are used as terms of description and not of limitation, and there is no intention that in the use of such terms and expressions of excluding any equivalents of the features shown and described or portions thereof, but it is recognized that various modifications are possible within the scope of the invention claimed. Also, while the inventions have been described in terms of preferred embodiments, it will be apparent to those of skill in the art that variations may be applied without departing from the spirit and scope of the invention as claimed herein. All such variations and equivalents apparent to those skilled in the art, whether now existing or later developed, are deemed to be within the spirit and scope of the invention as defined by the appended claims.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms.

All patents, patent applications, and publications mentioned in the specification are indicative of the levels of those of ordinary skill in the art to which the invention pertains. All patents, patent applications, and publications are herein incorporated by reference in their entirety for all purposes and to the same extent as if each individual publication was specifically and individually indicated to be incorporated by reference in its entirety for any and all purposes.

I claim:

1. A computer-based reverse auction method, comprising:
a. inputting into a computer a purchase order that comprises at least one item descriptor for a target product or service a buyer wishes to purchase, wherein the item descriptor(s) allows the target product or service to be distinguished from non-target products or services¹, and a ceiling purchase price for the target product or service²;
1 E.g., manufacturer name and catalog and/or SKU number.
2 The ceiling price could be determined by the buyer directly, automatically (e.g., by a computer-based search for the lowest price, which is then approved by the buyer; could also provide for an incremental reduction, say 5-10%), by some reference to some database maintained by the service (note also: the ceiling price need not be disclosed to seller); the price disclosed could be some lower price, which could in turn be slightly greater than a buyer-defined “SELL IT NOW” price, if included as an option in the reverse auction.
b. providing a payment indicator³ evidencing irrevocable availability of funds associated with the buyer in an amount sufficient to pay the ceiling purchase price if a closing occurs for a reverse auction corresponding to the purchase order;
3 For example, by inputting into the computer buyer payment information, which buyer payment information comprises a funding source for payment of the ceiling purchase price if a closing of a reverse auction corresponding to the buyer's purchase order occurs for the target product or service and obtaining from the funding source a payment indicator evidencing irrevocable availability of funds associated with the buyer in an amount sufficient to pay the ceiling purchase price if a closing of the reverse auction occurs.
c. obtaining an auction identifier for identification of a reverse auction corresponding to the purchase offer and payment indicator;
d. after obtaining the auction identifier, using the computer to initiate a reverse auction having a defined auction period (optionally 1-72 hours, 1-60 days, or 1-6 months) by transmitting a buyer's purchase offer to and soliciting acceptance thereof from at least one prospective seller, optionally an accredited seller, of the target product or service during the auction period, wherein the buyer's purchase offer comprises at least one of the item descriptors and a product/service purchase price equal to or less than the ceiling purchase price, and wherein acceptance of the buyer's purchase offer comprises a prospective seller of the target product or service providing during the auction period a selling price equal to or less than the product/service purchase price; and
e. if (X) no prospective optionally accredited seller accepts the buyer's purchase offer during the auction period, terminating the auction; (Y) one prospective optionally accredited seller accepts the buyer's purchase offer during the auction period, closing the auction at the conclusion of the auction period, fixing as the final sales price the selling price for the target product or service, and awarding the sale of the target product or service to such optionally accredited seller; or (Z) more than one prospective optionally accredited seller accepts the buyer's purchase offer during the auction period, closing the auction at the conclusion of the auction period, awarding the sale of the target product or service to the prospective optionally accredited seller that first accepted during the auction period the buyer's purchase offer on terms most favorable to the buyer, and fixing as the final sales price the selling price provided by the optionally accredited seller awarded the sale.

2. A method according to claim 1 that, if there is a closing, further comprises at least one of the following:
a. informing the buyer thereof, and optionally further comprising informing the buyer of the final sales price;
b. facilitating the seller's collection of payment of the final sales price for the target product or service; and/or
c. facilitating delivery or provision of the target product or service to the buyer.

3. A method according to claim 1 wherein a seller's acceptance of the buyer's purchase offer further comprises an agreement to deliver the target product or service upon receipt of payment equal to the final sales price⁴.
4 The final sales price may include sales tax, shipping and delivery charges, insurance, extended warranties and/or service plans, etc. Alternatively, the webpage showing the auction's status may include advertizing, links to other products/services (complementary or not), offers for extended warranties and/or service plans, shipping/delivery/insurance options, etc.

4. A method according to claim 1 wherein if no prospective seller accepts the initial buyer's purchase offer during the auction period, prior to terminating the auction, extending the auction period for an additional defined period if approved by the buyer and informing the prospective seller(s) from whom acceptance was earlier solicited of such extension.

5. A method according to claim 4 wherein extension of the auction period comprises extending the purchase order and/or the buyer's purchase offer.

6. A method according to claim 4 wherein if no prospective seller accepts the buyer's purchase offer during the auction period, replacing the buyer's purchase offer then in effect with a revised purchase offer comprising a revised product/service purchase price greater than the product/service purchase price to be replaced but equal to or less than the ceiling purchase price.

7. A method according to claim 1 wherein the buyer's purchase offer further comprises a “SELL IT NOW” price that is less than the product/service purchase price, wherein if a prospective seller accepts the buyer's purchase offer by agreeing during the auction period to sell the target product or service to the buyer at the “SELL IT NOW” price, closing the auction prior to conclusion of the auction period, fixing the “SELL IT NOW” price as a final sales price, and awarding the sale to such accredited seller.

8. A method according to claim 1 wherein when more than one prospective seller accepts the buyer's purchase offer during the auction period, prior to closing the auction at the conclusion of the auction period, (A) informing the prospective sellers of at least the lowest selling price then provided in the corresponding acceptances and allowing the prospective sellers to downwardly revise their respective selling prices, if desired, or (B) informing every prospective seller other than the prospective seller with the lowest selling price that another prospective seller participating in the reverse auction has provided a selling price less than such seller's respective selling price and allowing the prospective seller(s) so informed to downwardly revise their respective selling prices, if desired.

9. A method according to claim 8 wherein if a prospective seller downwardly revises its selling price such that at the conclusion of the auction period it first accepted the buyer's purchase offer on terms most favorable to the buyer, closing the auction, awarding the sale to such prospective seller, and fixing as the final sales price the downwardly revised selling price provided by such prospective seller.

10. A computer system, comprising in operable association:
a. a processor configured to execute computer control logic to perform a reverse auction in accordance with the method of claim 1;
b. an interface that allows receipt of information (R) required to complete a buyer's purchase order for a target product or service and (S) required to complete an optionally accredited accredited seller's acceptance of the buyer's purchase offer;
c. one or more storage devices for storing (T) data at least some of which is received through the first and/or second input device(s) and (U) at least some of the computer control logic used to perform the reverse auction; and
e. a power supply.
